(19) United States
(12) Patent Application Publication
(10) Pub. No.: US 2006/0059508 A1
(43) Pub. Date: Mar. 16, 2006

(54) Apparatus for providing conditional access to a stream of data

(75) Inventors: Franciscus Lucas Antonius Johannes Kamperman, Eindhoven (NL); Bartholomeus Johannes Van Rijnsoever, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V. GROENEWOUDSEWEG 1, EINDHOVEN (NL)

(21) Appl. No.: 10/520,313

(22) PCT Filed: Jun. 20, 2003
(86) PCT No.: PCT/IB03/02839

§ 371 Date: Jan. 5, 2005

(30) Foreign Application Priority Data
Jul. 11, 2002 (EP) 02077837.9

(51) Int. Cl. H04N 7/167; H04N 7/173

(52) U.S. Cl. 725/31; 725/100

(57) ABSTRACT

A decoder decrypts data from the stream of data, using decryption control words. A secure device is coupled to the decoder to supply the control words. The secure device has a memory space for storing at least two items of entitlement information with associated authorization keys. The secure device has an input for receiving messages from the apparatus. The message contains information for example about the source of the stream. The secure device contains an execution unit that responds to the messages by selecting from among die at least two items, if stored, dependent on a content of the messages. The execution unit enables sending of the control words to the decoder subject to the presence and validity of the selected one of the items of entitlement information, after decryption of the control word with a decryption key associated with the selected one of the items.

The invention relates to an apparatus for decoding a stream of data.

The MPEG standard provides for broadcasting transport streams that contain video and audio data. The data may be encrypted. This enables the broadcasters of the transport streams to control who can access the data in return for a subscription fee.

U.S. Pat. No. 5,461,675 describes a system for controlling access to a broadcast stream of data. Such a stream includes encrypted data and so called ECM's (Encryption Control Messages) and EMM's (Entitlement Management Messages). The encrypted data can be decrypted using control words. These control words are distributed in encrypted form in the ECM's. At the receiving side of the system the ECM's are fed to a secure device (usually a smart card) that decrypts the control words from the ECM's and supplies the decrypted control words to a decoder for decoding the encrypted data. Not all control words are decrypted. The secure device stores entitlement information, containing an authorization key for decrypting the control words from the ECM's and time related data. The time related data is regularly updated to mark the progress of time. The ECM's also contain time related data. The control words are decoded from the ECM's only if the appropriate authorization key and appropriate entitlement information for decrypting the ECM's is stored in the secure device and then only if the time related data from the ECM's relates to later a time than a time specified by the time related data that is stored in the secure device. Thus, decoding of data that has been stored for some time is prevented.

Authorization keys and entitlement information for decrypting the ECM's are distributed with the stream in the EMM's. In consumer systems, different consumers each have their own receiving apparatus to receive and decode the stream. Each apparatus is enabled separately to decode data, usually only for a limited time interval. For this purpose, EMM's and entitlement information for individual ones of the receiving apparatuses are included with the stream. Each EMM is encrypted so that it can only be decrypted with a key that is specific to the intended receiving apparatus. The receiving apparatus decrypts the authorization key for decrypting the ECM's from the EMM and stores it for later use in decryption of control words from ECM's. The EMM's also contain further entitlement information, that specifies for example for which programs the control words may be supplied and when.

U.S. Pat. No. 5,991,400 describes an apparatus that permits storage and controlled replay of a stream of encrypted data. The number of times the stream can be replayed may be controlled by enforcing updates of information in the secure device during replay.

For an optimal economic exploitation of the distribution of data streams it is desirable that access permission can be differentiated according to different modes of use of the data. The known techniques provide for prevention of decryption when the receiving apparatus does not contain the appropriate authorization key or entitlement information. Furthermore these apparatuses provide for the prevention of replay in general, or for a more refined control over replay, even when the appropriate authorization key for decrypting the information is present. It is, however, desirable to provide for more refined, or at least for an alternative way of differentiating control over replay of encrypted data.

Amongst others, it is an object of the invention to provide for a more refined, or at least for an alternative way of differentiating control over replay of encrypted data.

The invention provides for an apparatus according to claim 1. The apparatus provides for a secure device that has memory space for storing multiple decryption authorization keys or a plurality of alternative entitlements for decrypting control words and supports the supply of messages from outside the secure device that make the secure device select the decryption authorization key or entitlement information that has to be used, if present in memory (of course a decryption authorization key or entitlement information cannot effectively be selected if it is not stored in the memory space). Different authorization keys may be used to decrypt the control word in response to the messages. Thus, the selection of commands can be used to refine control over decryption. The messages may be explicit commands to make the secure device select a specific authorization key or entitlement information, or the messages may be an auxiliary to such commands or the messages may have other purposes, causing the secure device to make this selection as a side effect of passing information that is also useful for other purposes.

In an embodiment the content of the messages, and therefore selection of the authorization key or entitlement information depends on the source of the content the security device may act differently. Preferably, the apparatus sets the content of the messages dependent on the source of the stream, giving for example the command to use one of the stored decryption authorization keys when a stream from a broadcast receiver is detected and another one of the stored decryption authorization keys if replay of the stream from a storage device is detected, for example. Of course, it depends on information in the secure device whether such a command is executed or not. In this sense the command can also be regarded as a request, specifying a desired operation, subject to permission by the secure device. This allows for different exploitation of streams from different sources, by means of selective distribution of authorization keys for different sources.

In an embodiment partial streams are stored and the source of the stream is detected from the presence of a selection information table that describes the selection of the partial stream. Thus, a special key for enabling selected subscribers to access such stored partial stream is supported. Preferably, information to retrieve the authorization keys to decrypt the encrypted control words is included in the selection information table and retrieved only from that table. This has the effect that it is impossible to omit the table without making replay impossible.

In another embodiment common acceptance information for the plurality of decryption authorization keys is stored in the secure device, any of the decryption authorization keys being updated (including entered) only if they are accompanied by matching validation information. This makes it more difficult for unscrupulous persons to replace, e.g. by a replay (EMMs) attack, individual ones of the authorization keys or entitlements in an attempt to gain more access than allowed by the broadcaster.

These and other objects and advantageous aspects of the apparatus and method according to the invention will be described in more detail using the following figures.

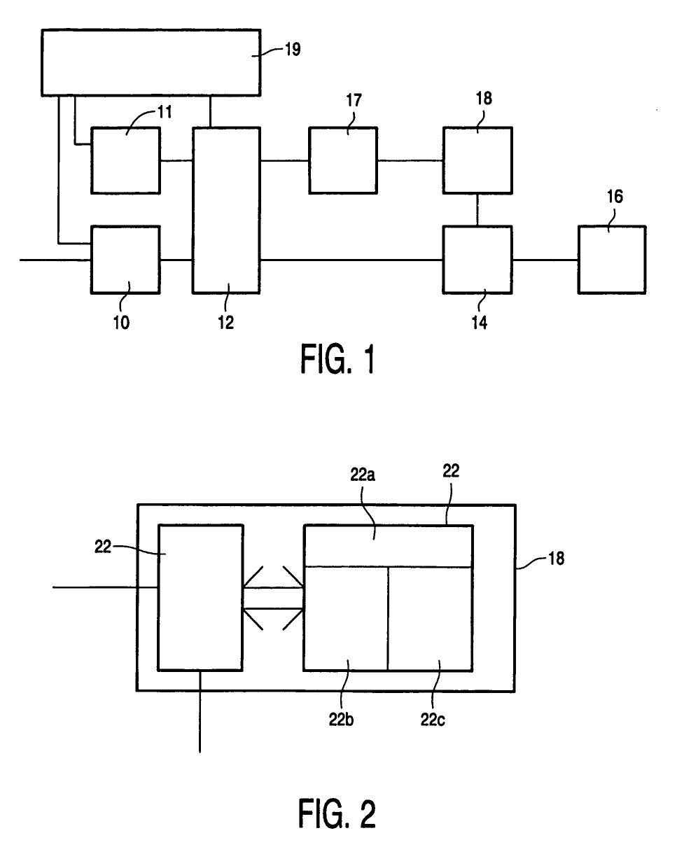

FIG. 1 shows an apparatus for decrypting data;

FIG. 2 shows a detail of a secure device.

FIG. 1 shows an apparatus that contains a receiver 10, a storage device 11, a multiplexer 12, a decoder 14, a rendering device 16, a source detector 17, a secure device 18 and a control interface 19. Receiver 10 and storage device 11 are coupled to a data input of decoder 14 via multiplexer 12, an output of multiplexer 12 is coupled to rendering device 16. Multiplexer 12 has an output coupled to detector 17, which has an output coupled to secure device 18, which in turn has an output coupled to a control input of decoder 14. Control interface 19 has an output coupled to control inputs of multiplexer 12, storage device 11 and receiver 10.

FIG. 2 shows secure device 18 in more detail. Secure device 18 contains an execution unit 20 and a memory 22. Three regions 22a-c of memory 22 are indicated. Execution unit 20 is coupled to memory 22 via a memory interface. Execution unit 20 has an input coupled to detector 17 and an output coupled to decoder 14 (not shown in FIG. 2).

In operation, the apparatus is capable of receiving data streams with receiver 10 and of replaying data streams from storage device 11. The apparatus is capable of decoding the received or replayed data streams and rendering the decoded data stream. A user selects the source via control interface 19, which commands receiver 10 or storage device 11 to produce the stream and which commands multiplexer 12 to pass data from the stream to decoder 14. Decoder 14 decodes the data for rendering by rendering device 16. Secure device supplies control words to decoder 14. The control words serve as keys that enable decoder 14 to decrypt the data. Secure device 18 obtains the control words from ECM's that accompany the data. Secure device 18 decrypts the control words from the ECM, using an authorization key that is stored in memory 22 of secure device 18.

Secure device 18 is realized for example in the form of a smart card with protection against tampering: it is practically impossible to extract information from secure device 18, electrically or otherwise, except with approval from software executed by execution unit 20. Secure device 18 has memory space for storing a plurality of authorization keys, together with entitlement information that determines when and under what circumstances secure device 18 may supply to the decoder 14 control words that have been decrypted using the authorization keys. By way of example, two memory regions 22b,c have been shown, each for storing a respective one of the authorization keys and entitlement information corresponding to that authorization key.

Detector 17 detects the source of the data stream that is supplied to decoder 14 by multiplexer 12. Furthermore, detector 17 obtains ECM's from multiplexer 12. In response detector 17 supplies commands to secure device 18, each commanding secure device 18 to decrypt one or more control words from an ECM and to supply that control word or those control words to decoder 14 (if needed (?) on request by decoder 14). The commands detector 17 also specifies which of the authorization keys from memory 22 of secure device 18 should be used to decrypt the control word or words. Detector 17 selects the authorization key that it specifies dependent on the detected source: when detector 17 detects that the data stream is a received broadcast data stream supplied from receiver 10 detector 17 issues a command to use a first one of the authorization keys and when detector detects that the data stream is a replayed data stream from storage device 11 detector 17 issues a command to use a second one of the authorization keys. These authorization keys may have different entitlements, restricted to data broadcast in mutually different time intervals for example, or to rendering in different time intervals. Thus, detector 17 issues commands dependent on the source of the information. Of course, secure device 18 decides whether or not to execute each command. If an appropriate entitlement or an appropriate key to execute the command is not available in secure device 18, it does not execute the command. In this respect, the commands can also be regarded as “requests”, and the use of source dependent commands can be regarded as including information about the source in the commands, which is used by secure device 18 to decide whether or not to execute the command.

Various types of commands may be used to select the authorization key that must be used. In one example, different kinds of command are available for decrypting control words from an ECM. The command for a particular ECM is selected according to the source of the ECM (e.g. live broadcast or from storage), so as to select the authorization key or the entitlement information that the secure device 18 should use to execute the command, if the command is executed. In another example, secure device 18 has an instruction set with a command to decrypt a control word from an ECM, in which the command has operands both to select the authorization key and at least a part of an ECM with a control word. These commands command secure device 18 to decrypt and use the control word and to use a specific authorization key or entitlement information to decrypt the control word. Of course, the secure device will not execute the command if the requested authorization key is not available and/or not entitled. Thus, it is impossible to tamper with the system by selecting the authorization key that should be used unrelated to the supply of the ECM's. In another example, the instruction set of secure device 18 contains separate commands for selecting authorization keys or entitlement information, separate, that is, from the commands to decrypt a control word from a certain ECM. This has the advantage of backward compatibility because conventional commands may be used to supply the encrypted control words.

Various techniques may be used to detect the source of the data stream. In one example, detector 17 receives an indication of the selected stream from multiplexer 12. In this case, storage device 11 is preferably an integral part of the apparatus of FIG. 1, for example in the form of a hard disk or a large scale semiconductor memory. Thus, it is ensured that the authorization key that is selected in case of replay is only used for data that is replayed from the internal storage. In another example, the apparatus is arranged to modify ECM's that are replayed from storage device 11 (at the time of replay and/or at the time of storage). In this case, detector 17 may be arranged to detect the source from the content of the ECM's themselves.

In yet another example, detector 17 detects the source from the presence or absence of a selection table. In MPEG transport streams for example, it is possible to work with partial streams that contain only part of the packets of an MPEG transport stream. This reduces the volume of data, freeing storage space in storage device 11 for storing other data, or freeing bandwidth that may be used for communication purposes. In order to be able to process such a partial MPEG transport stream the partial stream is supplemented with a special type of table, the selection information table (SIT), which indicates what has been selected and left out from the transport stream. The SIT enables reconstruction of the relevant time relations of the original transport stream during decoding and rendering of the partial stream. When detector 17 uses the presence of this table to detect the source, it is possible to use a separate authorization key (and separate subscriptions) for partial transport streams, allowing subscribers to buy the right to use partial transport streams (alleviating the demand on resources).

Preferably, this selection information table also contains information that is essential for retrieving the ECM's with the necessary control words, for example by including conditional access descriptors in the SIT (conditional access descriptors specify the PID's=packet identifiers of the packets that contain the ECM's; each packet in the stream contains its own PID and information about the PID permits the retrieval of relevant packets).

The authorization keys and entitlement information in memory 22 are preferably supplied in EMM's from a broadcast stream received by receiver 10. The broadcast stream with such EMM's may be received by any number of apparatuses of the type shown in FIG. 1, each with its own secure device 18. Each such EMM's are addressed to an individual secure device or to a group of such devices. The EMM's are passed to secure device 18, for example via detector 17, the secure device 18 processing the EMM when it is addressed to the secure device 18. Thus the broadcaster is able to control the type of access that is permitted to individual subscribers, so as to permit selectively whether it is permitted to replay and decode stored data from storage device 11 and to receive and live received data.

Preferably, measures are also taken to counteract tampering that makes use of selective replay of such EMM's. In an embodiment, this is realized by using acceptance numbers. In this embodiment, secure device 18 stores an acceptance number in memory, for example in a first region 22a of the memory 22 that is also used for the authorization keys. The broadcaster includes an acceptance number with broadcast EMM's, preferably so that this acceptance number cannot normally be tampered with. When secure device 18 receives an EMM that commands a change of entitlement information in memory 22 of the secure device 18, or a change of the authorization keys, execution unit 20 checks whether the acceptance number from the EMM corresponds to the acceptance number in memory 22. Correspondence may mean equality for example, but other forms of correspondence may be used, for example that the result of a applying a function of the received acceptance number equals the stored acceptance number. Execution unit 20 accepts, and may change, the entitlement information or the authorization key only if the acceptance numbers correspond. One acceptance number in memory 22 functions for a plurality of the different authorization keys that can be stored in respective regions 22b,c of memory 22. Thus changes to the entitlement information and the authorization keys in different regions 22b,2 of memory cannot be made completely independently of one another. As a result a tamperer cannot replay old EMM's to enable decoding of replay information without also affecting the capability of decoding live data.

Preferably, the instruction set of secure device 18 contains a command to update the acceptance number in memory 22 in response to a reception of the command. Such a command is preferably the result of passing an EMM that implies this command from the received stream. Preferably, execution unit 20 automatically also invalidates the entitlements of existing authorization keys in memory 22 in response to this command (or EMM). Alternatively, a separate command or EMM may be used to invalidate the entitlements. Thus, the acceptance number cannot be tampered with without invalidating the authorization information. In another embodiment, the broadcast command for updating the acceptance number is always broadcast linked to a command to invalidate the authorization information. This has a similar effect if the broadcast is replayed to tamper with the acceptance number.

Preferably, the broadcaster periodically sends such command to update the acceptance number. Randomly selected acceptance numbers may be used for this purpose, or successively increasing acceptance number may be used.

Table I illustrates the effect of acceptance numbers.

TABLE I

| | EMM | Stored | Accept |
|---|---|---|---|
| 1 | Update 1 | -,-,- | Y |
| 2 | Entitle 1, A | 1,-,- | Y |
| 3 | Entitle 1, B | 1,A,- | Y |
| 4 | Entitle 1, A | 1,A,B | N |
| 5 | Update 1, 2 | 1,A,B | Y |
| 6 | Entitle 1, A | 2,-,- | N |
| 7 | Entitle 2, B | 2,-,- | Y |
| 8 | Update 0, 1 | 2,-,B | N |
| 9 | Update 2, 3 | 2,-,B | Y |
| 10 | . . . | 3,-,- | . . . |

In table I the leftmost column provides row numbers (to aid reading of the table only). The second column describes commands generated in response to EMM's received from receiver 10. The commands have acceptance numbers (1, 2, 3) from the EMM's as operands, further operands (A, B) are entitlement information or authorization keys. The third column describes the acceptance number and entitlement information (or authorization key) stored in memory 22. The fourth column describes whether execution unit 20 of secure device effects the command, e.g. whether the EMM is accepted.).

Initially no acceptance number and entitlement information or authorization keys are stored in memory 22. When the update command from the first row is received secure device 18 sets the acceptance number in memory 22 to the number specified in the update command. Subsequently when secure device 18 receives the entitle command of the second row entitlement information or authorization keys A is set. Secure device 18 accepts this command because the acceptance number in the entitle command is equal to the acceptance number in memory 22.

Subsequently when secure device 18 receives the update command of the fifth row secure device 18 updates the acceptance number and erases (or at least disables) entitlement information or authorization keys from the memory. Secure device 18 accepts this command because the old acceptance number that is specified in the update command is equal to the acceptance number in memory 22. When the entitle command of the second row is repeated (as shown in the sixth row) secure device 18 rejects this commands because the acceptance number in the entitle command differs the acceptance number in memory 22. The entitlement information or authorization key is not updated. Secure device 18 reject the update command of the eight row because it does not specify the correct old acceptance number that is stored in memory 22.

It should be noted that the frequency with which “update” commands occur in table I relative to entitle commands is selected merely for illustrative purposes. It is desirable that the update commands to update the acceptance number are broadcast regularly. However, compared with table I, a greater number of entitle commands may be used between successive updates of the acceptance number, changing the scope of entitlement, or replacing one or more of the authorization keys a number of times between updates of the acceptance number. Preferably, however, the secure device blocks overwriting of each specific entitlement once that entitlement has been stored. This increases security against tampering by preventing later replay of different entitlement information as long as an acceptance number is valid.

Preferably, the updates of the acceptance numbers and checking of acceptance numbers in entitlement commands is performed by the same execution unit 20 that is used for decrypting the control words, but of course different hardware may be used without deviating from the invention. Preferably, a suitably programmed computer is used, but dedicated hardware may be used as well.

From this example it will be appreciated that the use of acceptance numbers prevents tampering by means of replay of EMM's with old acceptance numbers. When one of the authorization keys (say A) is needed for decoding live received data, and the key required for this purpose is regularly changed the apparatus is forced to replace the acceptance number regularly when it has to continue to be able to decode live data. However, because the acceptance number is changed, stored data can also only be decoded if the appropriate key for replay is supplied with the current acceptance number.

Although the invention has been illustrated using the embodiment of FIG. 1 it will be understood that the invention is not limited to that embodiment. For example, part or all of the source detection function of detector 17 may be performed by execution unit 20, as long as the commands supplied to secure device 18 contain sufficient information from which the source can be detected. Similarly, other functions such as that of decoder 14 and secure device 18 or multiplexer 12 and decoder 14 etc. may be partly or wholly combined. Moreover, the commands described are of course only example of possible commands that may be used to specify the source. Other types of commands, or commands that contain further information may be used.

1. An apparatus for decoding a stream of data, the apparatus comprising
a decoder for decrypting data from the stream, using decryption control words;
a secure device coupled to the decoder, the secure device comprising
a memory space for storing at least two items of entitlement information;
an input for receiving messages from the apparatus, and
an execution unit arranged to respond to the messages, by selecting selected on of the items from among the at least two items, if stored, dependent on a content of the messages, the execution unit enabling sending of the control words to the decoder subject to the presence and validity of the selected one of the items, after decryption of the control word with a decryption key associated with the selected one of the items.

2. An apparatus according to claim 1, the apparatus comprising a detector for determining a source of the stream of data, the detector being coupled to the input of the secure device, to control information in the messages that specifies the source, the execution unit selecting from the items dependent on the specified source of the stream.

3. An apparatus according to claim 1, the apparatus comprising a detector arranged to detect whether the stream is a partial stream selected from a larger stream, the detector controlling the content of the messages dependent on whether the stream is detected to be a partial stream or not respectively, the execution unit selecting a first one of the items and a second one of the items dependent on whether the stream is detected to be a partial stream or not respectively.

4. An apparatus according to claim 3, wherein the detector is arranged to detect whether the stream is a partial stream dependent on the presence of a section in the stream that contains a table that describes the selection of the partial stream, the detector supplying encrypted control word information retrieved through said table to the secure device for use in supplying the control words to the decoder in case of a partial stream, the detector supplying encrypted control word information retrieved through a dedicated conditional access table from the stream in case of a complete stream.

5. A method of storing a stream of data, the method comprising extracting data for a selected part of the stream and storing the data for the selected part but not a remainder of the stream, together with a selection information table that describes the selection made from the stream, the selection information table containing information necessary for accessing encrypted control word information for use in decrypting the selected part of the stream.

6. An apparatus according to claim 1, wherein the secure device comprises a further memory space for storing acceptance information, the execution unit being arranged to execute first commands for updating the items of entitlement information, and second commands for updating the acceptance information, the execution unit effecting updates of any of the items in response to the first commands only if these first commands contain validation information that matches the acceptance information stored in the further memory space when these further commands are received.

7. A method of decoding a stream of data, the method comprising
decrypting data from the stream, using decryption control words;
supplying the control words with a secure device enable by one of at least two items of entitlement information, that are stored in the secure device sending a message to the secure device to enable sending of the control words to the decoder subject to the presence of a selected one of the items of entitlement information, the control words being decrypted with a decryption key associated with the selected one of the items, the selected one of the items being specified by the message.
